(19) United States
(12) Patent Application Publication
(10) Pub. No.: US 2021/0270746 A1
(43) Pub. Date: Sep. 2, 2021

(54) SYSTEM AND METHOD FOR LABORATORY-GROWN DIAMOND DETECTION

(71) Applicant: Zvi YEHUDA, Ramat Gan (IL)

(72) Inventor: Zvi YEHUDA, Ramat Gan (IL)

(21) Appl. No.: 17/257,652

(22) PCT Filed: Jul. 16, 2019
(86) PCT No.: PCT/IL2019/050799

§ 371 Date: Jan. 4, 2021

Related U.S. Application Data
(60) Provisional application No. 62/724,859, filed on Aug. 30, 2018.

(51) Int. Cl. G01N 21/87; G01N 21/64

(52) U.S. Cl. CPC G01N 21/87; G01N 2021/6413; G01N 21/6456

(57) ABSTRACT

A diamond evaluation device includes a lightproof enclosure and a platform for supporting a diamond to be evaluated, the platform being transmissive of ultraviolet C (UVC) radiation. At least one source of UVC radiation to irradiate the diamond includes at least one source that is a lower source located below the platform on an opposite side of the platform from the diamond when the diamond is supported by the platform. A light detector detects visible light that is emitted by the diamond at least as phosphorescence after irradiation of the diamond. A display displays a result of detection of the emitted light so as to enable at least distinguishing between emission of phosphorescence that is characteristic of a laboratory-grown diamond, and an absence of phosphorescence that is characteristic of a natural diamond.

### FIELD OF THE INVENTION

The present invention relates to a system and method for detection of laboratory-grown diamonds.

### BACKGROUND OF THE INVENTION

Several techniques exist for the production of laboratory-grown diamonds, often referred to as synthetic diamonds. Common techniques include high-pressure high-temperature (HPHT) crystal formation and chemical vapor deposition (CVD) crystal formation. Diamonds formed by these techniques are often referred to as HPHT diamonds and CVD diamonds, respectively. In general, the composition and crystal structure of a laboratory-grown diamond is, for the most part, identical with that of a geologically formed natural diamond: carbon arranged in a diamond cubic crystal structure.

It is often important to distinguish between laboratory-grown diamonds and natural diamonds. For example, people who trade in gem-quality diamonds, who manufacture, sell, or buy jewelry, who are responsible for appraising gems or jewelry, and others, may be required (e.g., by the US Federal Trade Commission or by another body) to distinguish between laboratory-grown diamonds and natural diamonds.

Various optical techniques have been devised for distinguishing laboratory-grown diamonds from natural diamonds. For example, in some cases, various defects or impurities in the crystal structure of a laboratory-grown diamond may result in optical properties that may be measurable to distinguish the laboratory-diamond from a natural diamond.

### SUMMARY OF THE INVENTION

There is thus provided, in accordance with an embodiment of the present invention, a diamond evaluation device including: a lightproof enclosure; a platform for supporting a diamond to be evaluated, the platform transmissive of ultraviolet C (UVC) radiation; at least one source of UVC radiation to irradiate the diamond, at least one of the at least one source being a lower source located below the platform on an opposite side of the platform from the diamond when the diamond is supported by the platform; a light detector for detecting visible light that is emitted by the diamond at least as phosphorescence after irradiation of the diamond; and a display for displaying a result of detection of the emitted light so as to enable at least distinguishing between emission of phosphorescence that is characteristic of a laboratory-grown diamond, and an absence of phosphorescence that is characteristic of a natural diamond.

Furthermore, in accordance with an embodiment of the present invention, the light detector includes a camera for acquiring color images of the visible light that is emitted by the diamond.

Furthermore, in accordance with an embodiment of the present invention, the camera includes a camera of a smartphone, the enclosure including holding structure for holding the smartphone in place on the device.

Furthermore, in accordance with an embodiment of the present invention, a display screen of the smartphone is configured to display the result.

Furthermore, in accordance with an embodiment of the present invention, a display screen of the smartphone is a touchscreen, configured to display a user interface and receive touch gesture input from a user to control operation of the device.

Furthermore, in accordance with an embodiment of the present invention, a processor of the smartphone is configured to control operation of the sources and the camera.

Furthermore, in accordance with an embodiment of the present invention, the processor is configured to communicate with circuitry for operation of the sources via a Bluetooth, WiFi or cable connection.

Furthermore, in accordance with an embodiment of the present invention, the device is configured to display the detected phosphorescence as falsely colored pixels on a color image.

Furthermore, in accordance with an embodiment of the present invention, the at least one source further includes an upper source located above the platform.

Furthermore, in accordance with an embodiment of the present invention, the upper source is located so as to not obstruct a line of sight between the diamond and the light detector.

Furthermore, in accordance with an embodiment of the present invention, the light detector is further configured to detect visible light that is emitted as fluorescence by the diamond concurrently with irradiation of the diamond by the UVC radiation.

Furthermore, in accordance with an embodiment of the present invention, the device is configured to display a color image of the detected fluorescence.

Furthermore, in accordance with an embodiment of the present invention, the at least one source is configured to emit radiation in the range from 200 nm to 240 nm.

Furthermore, in accordance with an embodiment of the present invention, the light detector is configured to begin detecting phosphorescence within less than one second after the irradiation.

Furthermore, in accordance with an embodiment of the present invention, the platform is located in a drawer that is openable to enable access to the platform.

Furthermore, in accordance with an embodiment of the present invention, the platform includes a UVC-transmissive material selected from a group of materials consisting of quartz, fused silica, sapphire and calcium fluoride.

Furthermore, in accordance with an embodiment of the present invention, a distance between the lower source and the diamond is smaller than a distance between the upper source and the diamond.

There is further provided, in accordance with an embodiment of the present invention, a method of operation of a device for evaluating a diamond, the method including: irradiating a diamond with at least one source of UVC radiation of the device, at least one of the one source being located below a platform that supports the diamond, the platform being transmissive of the UVC radiation; beginning within less than one second after irradiation of the device, using a light detector of the device to detect visible light that is emitted by the diamond as phosphorescence; and displaying an indication of the phosphorescence of the diamond to enable distinguishing between phosphorescence that is characteristic of a laboratory grown diamond and an absence of phosphorescence that is characteristic of a natural diamond.

Furthermore, in accordance with an embodiment of the present invention, the method includes using the light detector to detect visible light that is emitted by the diamond as fluorescence concurrently with the irradiation, and displaying a color image of the fluorescence to enable distinguishing between non-blue fluorescence that is characteristic of a laboratory grown diamond and blue fluorescence.

Furthermore, in accordance with an embodiment of the present invention, the displaying includes applying a false color to indicate a location of the color image where phosphorescence was detected.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a synthetic diamond detection device, in accordance with an embodiment of the present invention.

FIG. 2 schematically illustrates the synthetic diamond detection device shown in FIG. 1, with its diamond access drawer open.

FIG. 3 schematically illustrates a sectional view showing interior components of the synthetic diamond detection device with open diamond access drawer shown in FIG. 2.

FIG. 4 schematically illustrates a sectional view showing interior components of the synthetic diamond detection device with closed diamond access drawer shown in FIG. 1.

FIG. 5 is a flowchart depicting a method of operation of a synthetic diamond detection device, in accordance with an embodiment of the present invention.

FIG. 6 is a flowchart depicting a method for automatic evaluation of a diamond.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

Some embodiments of the invention may include an article such as a computer or processor readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

In accordance with an embodiment of the present invention, a synthetic diamond detection device includes at least two radiation sources and a light detector. The light detector is configured to detect light that is emitted by the diamond during (fluorescence), and immediately following (phosphorescence), irradiation by the radiation sources. A processor is configured to received signals or other data from the light detectors that are indicative of the detected light, and to analyze the detector data from the light detectors. The processor is further configured to operate a display or other output device to display or otherwise output the results of the measurement and analysis. For example, the processor may be configured to output a result that is indicative of the fluorescence and phosphorescence of each evaluated diamond.

The output results may indicate, or may be indicative of, whether a diamond is likely to be a geologically-formed natural diamond, or laboratory-grown synthetic diamond. In some cases, the output results may indicate or be indicative of a process that was used to form a synthetic diamond, such as high-pressure high-temperature (HPHT) crystal formation or chemical vapor deposition (CVD) crystal formation.

The synthetic diamond detection device includes a platform for holding one or more diamond to be analyzed. In some cases, the platform may be provided with a holder having one or more indentations or compartments, e.g., in the form of a rectangular grid, for holding each diamond at a fixed location on the platform. In some cases the holder may be permanently attached to or incorporated into the platform. In some cases, the holder may be removable or replaceable, e.g., to accommodate a measurement on a piece of jewelry (e.g., ring, bracelet, pendant, or other piece) on which a diamond to be evaluated has been mounted.

When in operation, the diamond, radiation sources, and light detector are enclosed in a lightproof enclosure. The lightproof enclosure may include an opening, e.g., in the form of a door, drawer, removable cover, or other opening, to enable introduction of diamonds into the lightproof enclosure prior to operation of the synthetic diamond detection device. After insertion of the diamonds, closing the opening to the lightproof enclosure may prevent stray light from outside the lightproof enclosure from reaching the light detector.

The radiation sources are configured to emit ultraviolet radiation in the ultraviolet C (UVC) spectral range. For example, the emitted radiation may have a wavelength in the range of 200 nm to 240 nm. For example, the radiation source may include a gas discharge or vapor discharge radiation source, a light-emitting diode (LED) source, or another source capable of emitting UVC radiation. In some cases, the radiation source may be planar (e.g., having the form of a thin rectangle or other shape that is extended in two dimensions). In some cases, the radiation source may be include a diffuser to increase the uniformity of the irradiation over the surface of the platform over that of a radiation source that is lacking such a diffuser.

The radiation sources may be located as close as practicable to the irradiated diamonds so as to maximize the irradiation. A platform or holder for holding the diamonds may be made of a material that is transparent to UVC radiation. For example, a thin flat platform on which one or more diamonds may be placed may be made of quartz or another material that is transparent to UVC radiation.

Typically, one of the radiation sources may be an upper radiation source that is configured to irradiate the diamonds from above, e.g., being located on the same side of the platform as are the diamonds. Such an upper radiation source may be placed so as not to obstruct a line of sight from the irradiated diamond to the light detector. Another of the radiation sources may be a lower radiation source that is configured to irradiate the diamonds from below, e.g., being located on the opposite side of the platform from the irradiated diamonds. Such a lower radiation source may be placed very close to the diamonds being irradiated. For example, a minimal separation distance between the lower radiation source and an irradiated diamond may be limited only by the thickness of the platform and the structure of the radiation source itself.

Alternatively or in addition to an upper radiation source that is configured to irradiate a diamond from above, one or more radiation sources may be placed to the side of the diamond, e.g., located on the same side of the platform as is the diamond. Placement of such side irradiation sources may also be restricted to locations that do not obstruct the line of sight between the irradiated diamond and the light detector.

A synthetic diamond detection device having both a lower radiation source and an upper radiation source may be advantageous over a device with only a single radiation source, typically above the diamond to be evaluated. A distance between the lower radiation source and the diamonds may be significantly smaller than a distance between the diamonds and the upper radiation source. Thus, the intensity of the irradiation by the lower radiation source may be significantly greater than the intensity of the irradiation from the upper radiation source. For example, a nearest possible distance between the upper radiation source and the diamonds may be constrained to locations that do not block or obstruct a line of sight from the diamonds to the light detector. The increased intensity of the irradiation from the lower radiation source may be sufficient to induce detectible phosphorescence. The detection of phosphorescence, especially short term (e.g., for less than one second) phosphorescence, may, for example, enable distinguishing those CVD diamonds that emit blue fluorescence from most types of natural diamonds. On the other hand, the upper source may irradiate diamonds or parts of diamonds that would not be irradiated by a lower source alone. In particular, an upper radiation source may be advantageous when irradiating a diamond that is mounted in a setting.

The light detector may include a camera or other imaging or scanning device. The light detector may include a lens or other optics to enable distinguishing light that originates from one location on the platform (e.g., emitted by one diamond) from light that originates at another location on the platform (e.g., emitted by another diamond). For example, the light detector may include a charge-coupled device (CCD) camera or other camera that is configured to acquire color images or otherwise enable distinguishing light of one color or in one wavelength range from light of another color or wavelength range. For example, the light detector may include a typical red-green-blue (RGB) detector, with different pixels or detector elements optimized for detection of light in different parts of the visible spectrum. In some cases, a smartphone camera may serve as the light detector. For example, the synthetic diamond detection device may include structure for holding the smartphone such that the camera of the smartphone may view any diamonds that are placed on the platform.

A diamond that is irradiated with such UVC radiation may emit visible light by fluorescence as it is being irradiated by the UVC radiation. In some cases, the diamond may continue to emit visible light by phosphorescence for a period of time after irradiation by the UVC radiation has ceased. The characteristics of the visible light that is emitted by the diamond may be indicative of the type of diamond that is being irradiated.

For example, most natural diamonds fluoresce with blue light when irradiated with UVC radiation. This fluorescing stops when the irradiation ceases, so that these diamonds do not phosphoresce. Emission by laboratory-grown diamonds may depend on the details of their formation. For example, a typical HPHT diamond, when irradiated with UVC radiation, may fluoresce with colors other than blue. After the irradiation ceases, these HPHT diamonds the emission may continue as phosphoresce for an extended period of time of at least 10 seconds, and often longer (e.g., as long as a minute or more). Some CVD diamonds may fluoresce with colors other than blue when irradiated with UVC radiation and may continue to phosphoresce after cessation of the irradiation. Other CVD diamonds may fluoresce with blue light, similarly to natural diamonds. However, these other CVD diamonds continue to emit phosphorescent blue light after cessation of the irradiation for a short period only. For example, the phosphorescent emission of these other CVD diamonds typically decays to an undetectable level in less than one second.

A processor may be configured to control the radiation sources and the light detector. For example, the processor may include or consist of a processor of a smartphone whose camera is used to detect the light that is emitted by the diamonds. For example, the smartphone may be programmed with an application that is configured to interact with components of the synthetic diamond detection device so as to control their operation. In some cases, the smartphone may be configured to communicate with components of the synthetic diamond detection device, e.g., the radiation sources, via a Bluetooth connection, or via another wired or wireless connection.

For example, the processor may be configured to concurrently operate the radiation sources and the light detector so as to detect fluorescence of the irradiated diamonds. In some cases, the synthetic diamond detection device may be provided with an interlink that prevents operation of the radiation emitters unless all openings of the lightproof enclosure are closed. The processor may be configured to continue the detection of emitted phosphorescent light that is emitted by the diamonds after cessation of the irradiation.

In some cases, the processor may be configured to operate the light detector without illumination and prior to irradiation. For example, the prior operation of the light detector may yield a baseline reading that may be subtracted from detected light during and after irradiation. The baseline reading may be utilized to cancel out effects of any residual leakage of ambient light into the synthetic diamond detection device, or other background sources of light.

In some cases, the processor may be configured to operate the light detector using a source of visible light illumination. For example, a visible light photograph of the diamonds may assist a user of the synthetic diamond detection device to identify each analyzed diamond. In some cases, an image of the diamond when illuminated by visible light may assist a user in identifying those types of diamonds (e.g., type IIb diamonds or other types), that may be prone to exhibiting fluorescence and phosphorescence properties that are similar to those of some laboratory-grown diamonds. For example, when the camera of a smartphone is used as a light detector, visible light illumination with no UVC component may be provided by flash lamp of the smartphone.

The processor may be configured to analyze the detected light, e.g., acquired images of light that is emitted by the diamonds. For example, the processor may be configured to determine whether detected light, e.g., in a particular image frame, was emitted during or after irradiation. Thus, the processor may be configured to distinguish between detected fluorescence and phosphorescence of the diamonds. In some cases, the processor may be configured to indicate whether a diamond is likely to be natural or laboratory grown, or may indicate one or more possibilities for the source of the diamond.

In some cases, the processor may be configured to adjust sensitivity of the light detector. For example, the processor may be configured to adjusting an aperture or exposure time of a camera, may apply a threshold reading, or otherwise control a sensitivity of detection of light by the light detector. In some cases, the sensitivity may be increased when a user indicates that a diamond that is being identified is mounted in a setting, e.g., of jewelry or an ornament. For example, increasing the sensitivity when a diamond is mounted in a setting may compensate for blockage of irradiating UVC radiation, of emitted visible light, or both by the setting.

The processor may be configured to operate an output device in order to output results of the light detection and analysis. In some cases, the results may be displayed on a display screen of a smartphone that is in communication with, or is incorporated into, the synthetic diamond detection device.

In some cases, the display may include a color image of the fluorescent light that is emitted by the diamonds during irradiation, superimposed with a false color image of the phosphorescent light. In such cases, the perception of the user may be relied upon to distinguish blue fluorescence from fluorescence in any other color (e.g., yellow, green, red, orange, or purple). The false color that indicates phosphorescent light may be solid red or another color that is readily visible to a typical user. In some cases, the false color is binary, e.g., either on or off in a given pixel, without intermediate levels. Thus, in these cases, the presence or absence of false color may indicate either the presence or absence of the detected phosphorescent light, and not its intensity (e.g., over a threshold intensity). Thus, the display may enable a user to distinguish between a diamond that displays phosphorescence that is generally characteristic of a laboratory grown diamond, and an absence of phosphorescence that is characteristic of most natural diamonds.

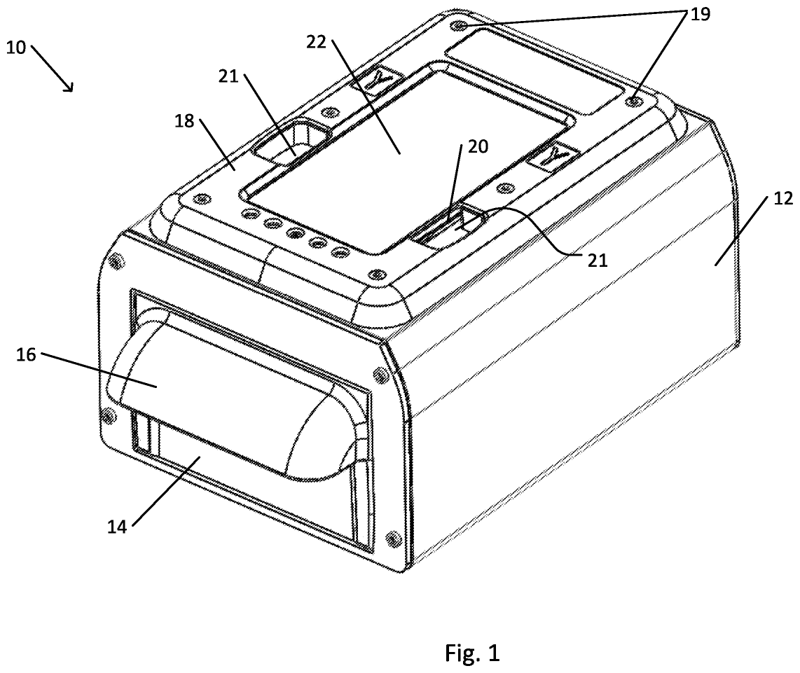

FIG. 1 schematically illustrates a synthetic diamond detection device, in accordance with an embodiment of the present invention.

Synthetic diamond detection device 10 is configured to enable evaluation of one or more diamonds that are placed in the device so as to indicate whether the diamonds are natural or laboratory grown. Device housing 12 is configured to be lightproof. Thus, when diamonds are inserted into synthetic diamond detection device 10 for evaluation, ambient light may be prevented from leaking into the interior of device housing 12, or may be at least attenuated to a level so as not to interfere with operation of synthetic diamond detection device 10.

Device housing 12 may be provided with one or more openings to enable insertion of one or more diamonds into synthetic diamond detection device 10. In the example shown, the opening is in the form of diamond access drawer 14. In the example shown, diamond access drawer 14 may be opened or closed by pulling or pushing, respectively, on drawer handle 16. Other mechanisms may be used to open or close a diamond access drawer 14, or another access opening in device housing 12 of synthetic diamond detection device 10.

In the example shown, device housing 12 is provided with smartphone holding structure 18 for attaching a smartphone 20 to synthetic diamond detection device 10. Smartphone 20 is attached to synthetic diamond detection device 10 such that smartphone display screen 22 of smartphone 20 is exposed. Typically, smartphone display screen 22 is a touchscreen, enabling input by touching or tapping the screen, or by sweeping a finger or stylus across the screen. Thus, a user of synthetic diamond detection device 10 may operate smartphone 20, and thus synthetic diamond detection device 10, by interacting with smartphone display screen 22. For example, a user interface for operation of synthetic diamond detection device 10 may be displayed on smartphone display screen 22 of smartphone 20. The user may view images or other information that are displayed on smartphone display screen 22.

Smartphone holding structure 18 may include one or more smartphone control access openings 21 to enable access to one or more controls of smartphone 20. For example, smartphone control access openings 21 may enable access to one or more of an on/off button, a volume control, to a jack or socket, or another control or component of smartphone 20.

In the example shown, synthetic diamond detection device 10 is configured to utilize one or more components of smartphone 20 during operation. For example, a camera of smartphone 20 may be oriented so as to acquire light images of a diamond that is being evaluated by synthetic diamond detection device 10. A processor of smartphone 20 may be utilized to control at least some operations of synthetic diamond detection device 10. One or more control buttons of smartphone 20 may be operated, e.g., to overcome problems or to operate one or more components of smartphone 20. In other examples, a synthetic diamond detection device may include similar components

In the example shown, smartphone holding structure 18 is configured to permanently attach smartphone 20 to synthetic diamond detection device 10. For example, as in the example shown, smartphone holding structure 18 is attached to device housing 12 by one or more fasteners 19. Fasteners 19 may include screws, as in the example shown, rivets, adhesives, welding, soldering, or other structure that requires use of tools in order to be opened. One or more both of smartphone 20 and smartphone holding structure 18 may be provide with a seals that may be inspected to reveal if a fastener 19 has been opened by an unauthorized person (e.g., anyone other than authorized maintenance, marketing, manufacturing, or other authorized personnel). Thus, in the example shown, smartphone 20 may be provided with only the electronics, components, or programming that is required for operation of synthetic diamond detection device 10.

In other examples, smartphone holding structure 18 may be configured to be opened by a user of synthetic diamond detection device 10. For example, in such an example, a user may be able to attach one's personal smartphone, or any smartphone that is programmed with an appropriate application, to synthetic diamond detection device 10. In such an example, smartphone holding structure may include a hinge, one or more latches, or other structure that may be opened and closed by a user of synthetic diamond detection device 10.

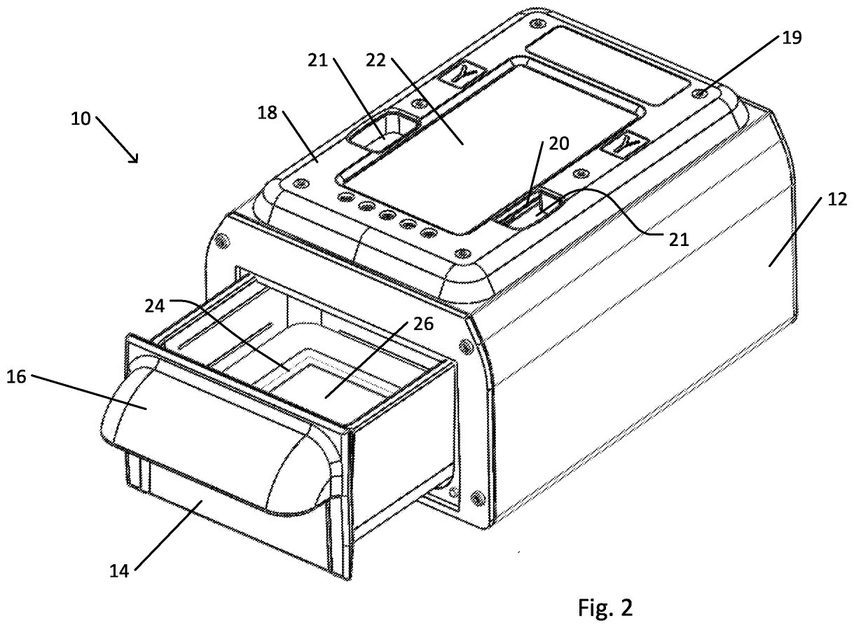

FIG. 2 schematically illustrates the synthetic diamond detection device shown in FIG. 1, with its diamond access drawer open.

Diamond access drawer 14 may be opened by pulling diamond access drawer 14 out of synthetic diamond detection device 10, e.g., by pulling on drawer handle 16. In some cases, diamond access drawer 14 may be provided with an electronically controlled latch or other locking mechanism. For example, the latch or locking mechanism may be configured to open only when an access code is entered, or when an authorizing device is used. Such an authorizing device may include an optically, magnetically, or electromagnetically detectable component.

When diamond access drawer 14 is open, one or more diamonds may be placed on diamond support platform 24. In some cases, diamond support platform 24 may be provided with structure to hold one or more diamonds in place. For example, a diamond support platform 24 may include an array or arrangement of indentations for holding unmounted diamonds. In some cases, an arrangement of partitions in the form of a rectangular lattice or other form may be placed atop diamond support platform 24 in order to hold unmounted diamonds at fixed positions relative to one another. One or more types of specialized holder may be provided for holding various types of rings or other articles on which diamonds are mounted. In some cases, diamonds, and in particular diamonds that are mounted in settings, may be placed on a flat diamond support platform 24.

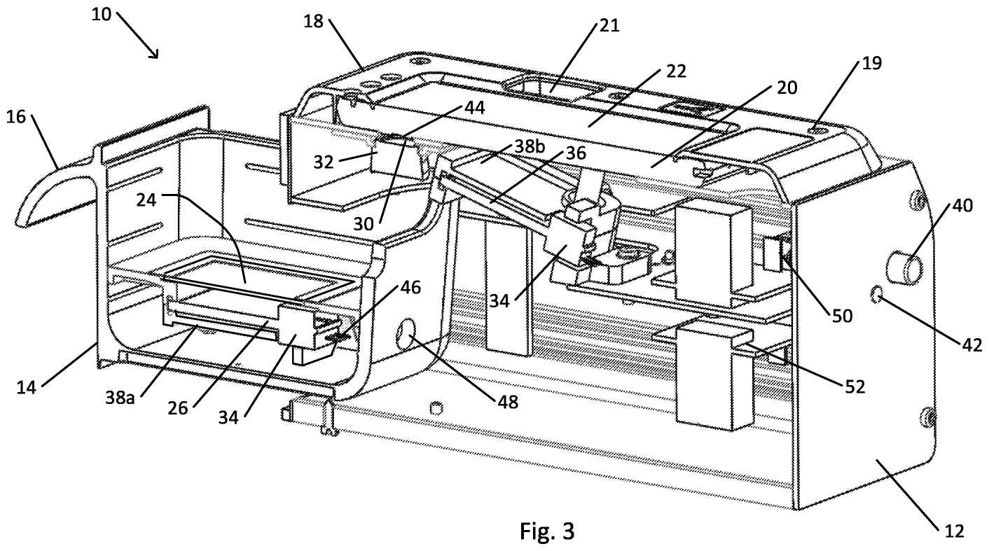

Diamond support platform 24 may be configured to transmit UVC radiation. For example, diamond support platform 24 may be constructed of a material that is transmissive of UVC radiation. For example, the material may be sufficiently transparent to or translucent to UVC radiation such that phosphorescence emitted by a diamond that is irradiated by lower radiation source 26 via diamond support platform 24 is detectable by light detector 44 (FIG. 3). Examples of such materials may include quartz, fused silica, sapphire, calcium fluoride, or other materials.

Lower radiation source 26 may be located below diamond support platform 24. Lower radiation source 26 is configured to irradiate a diamond that is placed on diamond support platform 24 from below, e.g., from side of diamond support platform 24 that is opposite the side on which the diamond is placed. Thus, if diamond support platform 24 is sufficiently transparent to UVC radiation, a diamond that is placed on diamond support platform 24 may be irradiated by UVC radiation that is emitted by lower radiation source 26.

Lower radiation source 26 may be configured to uniformly irradiate diamond support platform 24. Thus, diamonds that are placed on diamond support platform 24 may be irradiated with approximately identical intensities of UVC radiation regardless of placement on diamond support platform 24.

For example, lower radiation source 26 may include a gas discharge tube whose envelope and electrodes are shaped to cause a gas discharge in a region whose size and shape is similar to that of diamond support platform 24. As another example, lower radiation source 26 may include a plurality of smaller radiation emitting elements that are distributed in a region whose size and shape is similar to that of diamond support platform 24. Such radiation emitting elements may include, for example, cylindrical gas discharge tubes or light emitting diodes. When lower radiation source 26 includes such distributed smaller radiation emitting elements, lower radiation source 26 may include diffusing optics, such as a textured reflective or refractive surface. Such diffusing optics may increase the uniformity of radiation that is emitted by the radiation emitting elements and that irradiates diamonds on diamond support platform 24.

FIG. 3 schematically illustrates a sectional view showing interior components of the synthetic diamond detection device with open diamond access drawer shown in FIG. 2.

In FIG. 3, in order not to obscure the view of interior components, electrical connecting wires and cables and other common components are not shown.

In the position shown in FIG. 3, with diamond access drawer 14 opened diamond support platform 24 is exposed to enable placement of one or more diamonds on diamond support platform 24. Any structure for holding a diamond in place on diamond support platform 24 is not shown.

Diamond support platform 24 is located directly above lower radiation source 26. In the example shown, the minimum distance between diamond support platform 24 and lower radiation source 26 is limited by the size of radiation source base 34. For example, radiation source base 34 may include circuitry to enable radiation by lower radiation source 26, e.g., circuitry for creating a gas discharge or for operating a light emitting diode to produce UVC radiation.

Radiation source base 34 may include one or more source base connectors 46 for connecting radiation source base 34 to control circuitry 50. For example, a connector that connects source base connectors 46 to control circuitry 50 may pass through one or more cable openings 48 in a wall of diamond access drawer 14 or elsewhere within device housing 12 or synthetic diamond detection device 10. Control circuitry 50 may be held or supported by one or more circuitry support structures 52.

Control circuitry 50 may include circuitry for controlling the supply of electrical power to a radiation source base 34 of one or more lower radiation sources 26 and upper radiation sources 36. Control circuitry 50 may be provided with electrical power from one or more external electrical sources via power connector 40. For example, power connector 40 may be connected directly to a wall socket or power mains, to a power converter, to a battery or battery pack, or to another external source of electrical power. When required, control circuitry 50 may include one or more components for transforming or modifying electrical power from the external power source to a type, voltage, current, or frequency suitable for operation of lower radiation source 26 or upper radiation source 36. Synthetic diamond detection device 10 may include one or more indicators, such one or more indicator lights 42, to indicate when synthetic diamond detection device 10 is connected to a power supply, is switched on, or otherwise indicated a status of synthetic diamond detection device 10. In some cases, synthetic diamond detection device 10 may include an on-off switch, or one or more other controls that are located on an outer surface of device housing 12.

Control circuitry 50 may include a processor for controlling operation of one or more components of synthetic diamond detection device 10. Alternatively or in addition, control circuitry 50 may be configured to communicate with a processor of smartphone 20 so as to be controlled by the processor of smartphone 20. For example, control circuitry 50 may be provided with a Bluetooth connection, WiFi, or cable connection to communicate with a cooperating connection or connector on smartphone 20. In other examples, control circuitry 50 may be configured to communicate via a Universal Serial Bus (USB) cable, or otherwise communicate via a wired or wireless connection.

One or both of lower radiation source 26 and upper radiation source 36 may be held or supported by radiation source support structure 38a and 38b, respectively. For example, radiation source support structure 38a or 38b may include one or more slots, holders, latches, or other structure that is configured to hold lower radiation source 26 or upper radiation source 36 in place. Radiation source support structure 38a may be configured to hold lower radiation source 26 at a fixed position relative to diamond support platform 24 within diamond access drawer 14. Radiation source support structure 38b may be configured to hold upper radiation source 36 at a fixed position relative to smartphone 20 and relative to a position of diamond support platform 24 when diamond access drawer 14 is closed. One or both of radiation source support structures 38a and 38b may include reflecting structure to direct all emitted UVC radiation toward diamond support platform 24. Similarly, one or both of radiation source support structures 38a and 38b, e.g., a reflecting surface of radiation source support structure 38a or 38b, may include scattering or diffusing structure to enable lower radiation source 26 or upper radiation source 36 to function as a diffuse and homogenous radiation source.

Upper radiation source 36 is configured to irradiate a diamond that is placed on diamond support platform 24 from above, e.g., from the side of diamond support platform 24 on which the diamond is placed and on which light detector 44 is positioned. In some cases, upper radiation source 36 may be placed closer to diamond support platform 24 so as to irradiation diamond support platform 24 from the side, or an additional radiation source may be placed so as to irradiate diamond support platform 24 from the side.

Upper radiation source 36 is positioned so as not to obstruct a line of sight between any diamond that is supported on diamond support platform 24 and light detector 44. In the example shown, a camera of smartphone 20 is configured to function as light detector 44. Alternatively or in addition, synthetic diamond detection device 10 may be provided with a built-in imaging device or other light detector.

In the example shown, device housing 12 includes camera aperture 30 that is configured such that the camera of smartphone 20 is aligned with camera aperture 30 when smartphone 20 is attached to synthetic diamond detection device 10 using smartphone holding structure 18. The position of camera aperture 30 may be configured to enable light detector 44 to image all diamonds that are supported by diamond support platform 24.

Camera aperture 30 may be provided with camera optics 32. For example, camera optics 32 may include lenses or other optics to adapt any built-in optics within smartphone 20 to imaging diamonds on diamond support platform 24. Camera optics 32 may include one or more irises or adjustable apertures to control an amount of light that is admitted to light detector 44. For example, an iris may be adjusted to admit more light when the amount of light that is emitted by the diamonds is expected to be relatively low, e.g., when a diamonds is mounted in a setting. Camera optics 32 may include one or more of collimating optics, filtering optics, or other optical components.

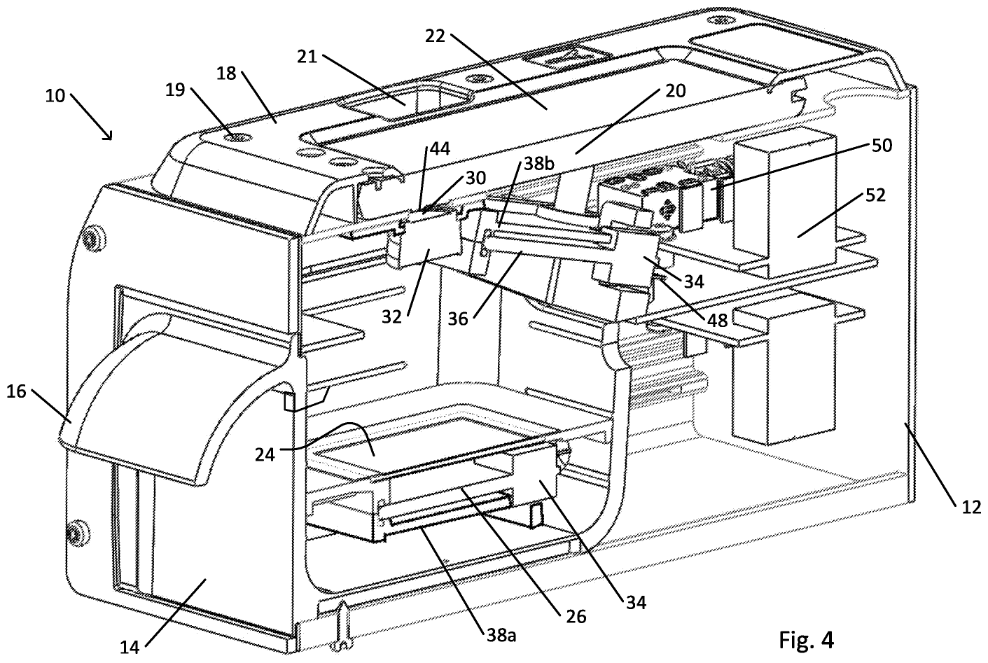

FIG. 4 schematically illustrates a sectional view showing interior components of the synthetic diamond detection device with closed diamond access drawer shown in FIG. 1.

As shown, when diamond access drawer 14 is closed, upper radiation source 36 is positioned relative to diamond support platform 24 so as to irradiate diamond support platform 24. In some cases, upper radiation source 36 or radiation source support structure 38b may be configured to enhance direction of UVC radiation that is emitted by upper radiation source 36 toward diamond support platform 24.

Closing diamond access drawer 14 may close all openings in device housing 12 such that device housing 12 becomes lightproof. For example, outer ends of diamond access drawer 14, e.g., on the side that includes drawer handle 16, may be surrounded with appropriate sealing structure to block entry of light into device housing 12 through edges of diamond access drawer 14. Such sealing structure may include gaskets, brushes, or other flexible structure that may bend to fill in any gaps between parts of diamond access drawer 14 and device housing 12.

In some cases, diamond access drawer 14, device housing 12, or both may be provided with a sensor to sense when diamond access drawer 14 is fully closed. In some cases, control circuitry 50 may include an interlock system, e.g., to prevent operation of lower radiation source 26 or of upper radiation source 36 when diamond access drawer 14 is not fully closed. In some cases, programming of a processor, e.g., of smartphone 20, may be configured to prevent operation of lower radiation source 26 or upper radiation source 36 when diamond access drawer 14 is not fully closed.

When synthetic diamond detection device 10 is in operation, smartphone display screen 22 of smartphone 20 may be operated to display one or more user interfaces. For example, a user may interact via a user interface to indicate whether a diamond to be evaluated is mounted or unmounted. In some cases, the user interface may enable entering of identifying data regarding the diamonds. The user interface may enable the user to select an image or data to be displayed, to store data for later retrieval, to retrieve previously stored data, to compare two sets of data, or other operations.

Alternatively or in addition to a user interface that is displayed on smartphone display screen 22, a user interface may include one or more user operable controls, or may be presented on a portable or fixed computer or computing device that is in communication with synthetic diamond detection device 10.

A processor of synthetic diamond detection device 10 may be configured to operate components of synthetic diamond detection device 10 to perform a measurement to detect synthetic diamonds.

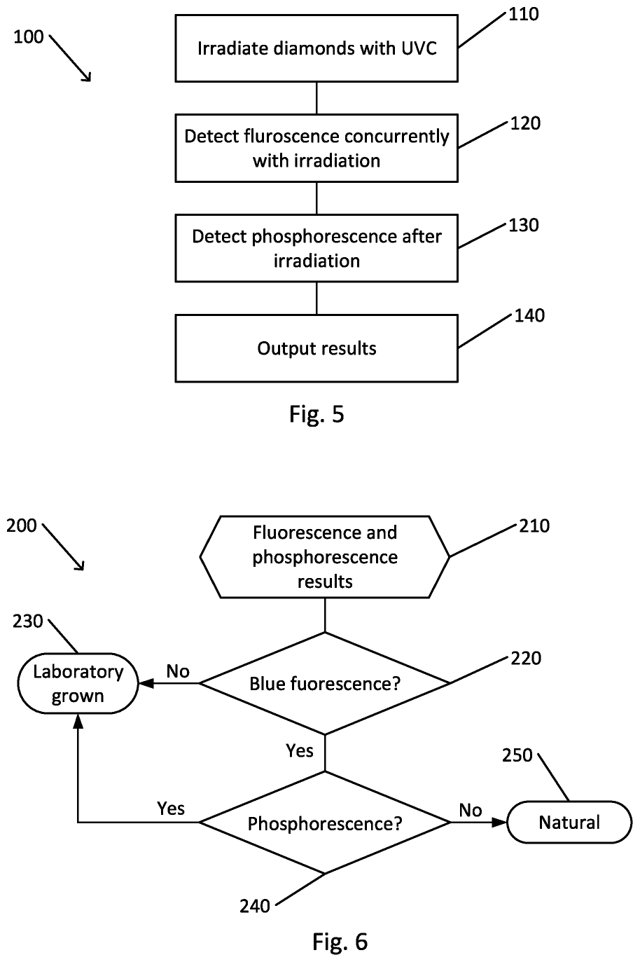

FIG. 5 is flowchart depicting a method of operation of a synthetic diamond detection device, in accordance with an embodiment of the present invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Synthetic diamond detection device operation method 100 may be executed by a processor or other controller of synthetic diamond detection device 10. For example, synthetic diamond detection device operation method 100 may be executed by a processor of smartphone 20 that is attached to device housing 12 by smartphone holding structure 18.

Synthetic diamond detection device operation method 100 may be executed when diamond access drawer 14 is closed, and with one or more diamonds placed on diamond support platform 24. For example, in the case of an unmounted diamond, the diamond may be advantageously placed on diamond support platform 24 such that a pavilion of the diamond rests on diamond support platform 24.

In some cases, prior to executing operations of synthetic diamond detection device operation method 100, light detector 44 may be operated to acquire one or more images or measurements. For example, an image of the diamonds may be acquired under visible light illumination. Such an image may assist a user in identifying each imaged diamonds, for verifying correct placement of a diamond on diamond support platform 24, or for other purposes. In some cases, an image or measurement may be acquired with no illumination, e.g., to measure any baseline signals that result from operation of light detector 44, e.g., due to electronic noise, light leakage, or other causes.

The diamond support platform 24 may be irradiated with UVC radiation (block 110). For example, lower radiation source 26 and upper radiation source 36 may be operated to produce UVC radiation.

Concurrently with the UVC irradiation, fluorescence may be detected by light detector 44 (block 120). For example, light detector 44 in the form of a camera, e.g., of smartphone 20, may be operated to acquire images of diamonds on diamond support platform 24 as diamond support platform 24 is being irradiated. For example, light detector 44 may be configured so as to not be sensitive to UVC radiation. Alternatively or in addition, camera optic 32 may include a filter to block transmission of UVC radiation to light detector 44.

When UVC irradiation has ceased, phosphorescence may be detected (block 130). For example, light detector 44 in the form of a camera, e.g., of smartphone 20, may be operated to acquire images of diamonds on diamond support platform 24 after diamond support platform 24 was irradiated.

In some cases, light detector 44 may be operated continuously both during irradiation and after irradiation. In such a case, a processor that acquires the images may distinguish between fluorescence images that are acquired during irradiation, and phosphorescence images that are acquired after irradiation. In other cases, after acquisition of fluorescence images, light detector 44 may stop operation and resume operation immediately following the end of the irradiation.

Continuous operation of light detector 44 or resumption of operation immediately upon the end of irradiation may enable light detector 44 to detect fast short-term phosphorescence. Such short-term phosphorescence may continue for a period of less than one second, and possibly shorter. In other cases, phosphorescence may continue for periods of 10 seconds or longer.

The results of the fluorescence and phosphorescence measurements may be output in a manner to enable evaluation of the diamonds on diamond support platform 24 (block 140).

For example, in some cases a fluorescence image may be displayed as a color image. Visual inspection of the fluorescence image by the user may enable the user to determine the color of the fluorescence. Typically, a natural diamond is characterized by blue fluorescence, while fluorescence in any other color indicates a synthetic diamond. However, some CVD synthetic diamonds and most HPHT diamonds may fluoresce in blue. However, such CVD diamonds are also characterized by short term phosphorescence, and HPHT diamonds are also characterized by long term phosphorescence, while natural diamonds exhibit no phosphorescence.

In some cases, phosphorescence may be displayed together with fluorescence. For example, a pixel where phosphorescence was detected (e.g., with an intensity that is greater than a predetermined threshold), may be indicated by coloring that pixel with a predetermined color, such as solid red or another predetermined color). Thus, the presence of any falsely colored pixels in the fluorescence image of a diamond may indicate phosphorescence by that diamond, and thus indicate that that diamond is laboratory grown.

Thus inspection of such a combined fluorescence and phosphorescence image may enable immediate determination of whether a diamond is natural or laboratory grown. If the fluorescence image is blue and no phosphorescence false coloring is present, the diamond is a natural diamond. If the fluorescence is not blue then the diamond is laboratory grown.

If the fluorescence is blue and phosphorescence is indicated, the diamond is usually laboratory grown. However, natural diamonds of some types, e.g., type IIa or IIb, may also exhibit blue fluorescence and phosphorescence. Thus, in some cases when the fluorescence is blue and phosphorescence is indicated, or if the fluorescence is not unambiguously blue, additional evaluation of the diamond may be required.

In some cases, a user may operate a user interface to save the results or to retrieve previously saved results. In some cases, a user may select between different displays of the acquired measurements. For example, the user may select to display an image acquired with visible illumination, an image of the fluorescence, an image showing or indicating the phosphorescence, or a combined image (e.g., showing both fluorescence and phosphorescence, or another combination).

Is some cases, a processor of synthetic diamond detection device 10 may be configured to automatically evaluate a diamond to identify whether the diamond is natural or laboratory grown.

FIG. 6 is a flowchart depicting a method for automatic evaluation of a diamond.

For example, diamond evaluation method 200 may be executed by a processor of synthetic diamond detection device 10 after acquisition of fluorescence and phosphorescence measurements (block 210).

Image processing techniques may be applied to identify diamond images in the measurement data. The color of the fluorescence of each diamond may be determined (block 220). For example, RGB pixel data may be evaluated to determine a color of a region of an image of a diamond.

If the color of the fluorescence is not blue, then the diamond may be determined to be laboratory grown (block 230).

If the fluorescence is blue, then the measurements may be checked for the presence of phosphorescence (block 240).

If no phosphorescence is detected, then the diamond is determined to be a natural diamond (block 250).

If phosphorescence and blue fluorescence is detected, then the diamond may be determined to be a laboratory grown diamond (block 230). However, in this case, a user may be warned that some types of diamonds may also exhibit the combination of blue fluorescence together with phosphorescence.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A diamond evaluation device comprising:
a lightproof enclosure;
a platform for supporting a diamond to be evaluated, the platform transmissive of ultraviolet C (UVC) radiation;
at least one source of UVC radiation to irradiate the diamond, at least one of said at least one source being a lower source located below the platform on an opposite side of the platform from the diamond when the diamond is supported by the platform;
a light detector for detecting visible light that is emitted by the diamond at least as phosphorescence after irradiation of the diamond; and
a display for displaying a result of detection of the emitted light so as to enable at least distinguishing between emission of phosphorescence that is characteristic of a laboratory-grown diamond, and an absence of phosphorescence that is characteristic of a natural diamond.

2. The device of claim 1, wherein the light detector comprises a camera for acquiring color images of the visible light that is emitted by the diamond.

3. The device of claim 2, wherein the camera comprises a camera of a smartphone, the enclosure comprising holding structure for holding the smartphone in place on the device.

4. The device of claim 3, wherein a display screen of the smartphone is configured to display the result.

5. The device of claim 4, wherein a display screen of the smartphone is a touchscreen, configured to display a user interface and receive touch gesture input from a user to control operation of the device.

6. The device of claim 3, wherein a processor of the smartphone is configured to control operation of the sources and the camera.

7. The device of claim 6, wherein the processor is configured to communicate with circuitry for operation of the sources via a Bluetooth, WiFi or cable connection.

8. The device of claim 1, wherein the display is configured to display the detected phosphorescence as falsely colored pixels on a color image.

9. The device of claim 1, wherein said at least one source further comprises an upper source located above the platform.

10. The device of claim 9, wherein the upper source is located so as to not obstruct a line of sight between the diamond and the light detector.

11. The device of claim 1, wherein the light detector is further configured to detect visible light that is emitted as fluorescence by the diamond concurrently with irradiation of the diamond by the UVC radiation.

12. The device of claim 11, wherein the device is configured to display a color image of the detected fluorescence.

13. The device of claim 1, wherein said at least one source is configured to emit radiation in the range from 200 nm to 240 nm.

14. The device of any of claim 1, wherein the light detector is configured to begin detecting phosphorescence within less than one second after the irradiation.

15. The device of any of claim 1, wherein the platform is located in a drawer that is openable to enable access to the platform.

16. The device of any of claim 1, wherein the platform comprises a UVC-transmissive material selected from a group of materials consisting of quartz, fused silica, sapphire and calcium fluoride.

17. The device of claim 1, wherein a distance between the lower source and the diamond is smaller than a distance between the upper source and the diamond.

18. A method of operation of a device for evaluating a diamond, the method comprising:
irradiating a diamond with at least one source of UVC radiation of the device, at least one of said one source being located below a platform that supports the diamond, the platform being transmissive of the UVC radiation;
beginning within less than one second after irradiation of the device, using a light detector of the device to detect visible light that is emitted by the diamond as phosphorescence; and
displaying an indication of the phosphorescence of the diamond to enable distinguishing between phosphorescence that is characteristic of a laboratory grown diamond and an absence of phosphorescence that is characteristic of a natural diamond.

19. The method of claim 18, further comprising using the light detector to detect visible light that is emitted by the diamond as fluorescence concurrently with the irradiation, and displaying a color image of the fluorescence to enable distinguishing between non-blue fluorescence that is characteristic of a laboratory grown diamond and blue fluorescence.

20. The method of claim 19, wherein the displaying comprises applying a false color to indicate a location of the color image where phosphorescence was detected.
